(19) United States
(12) Patent Application Publication
(10) Pub. No.: US 2026/0350042 A1
(43) Pub. Date: Nov. 5, 2026

(54) METHOD AND SYSTEM TO IMPLEMENT DOCUMENT RELATIONSHIPS

(71) Applicant: Box, Inc., Redwood City, CA (US)

(72) Inventor: Virender Gupta, Morganville, NJ (US)

(73) Assignee: Box, Inc., Redwood City, CA (US)

(21) Appl. No.: 19/195,549

(22) Filed: Apr. 30, 2025

(51) Int. Cl. G06F 16/28; G06F 16/93

(52) U.S. Cl. CPC G06F 16/288; G06F 16/93

(57) ABSTRACT

Methods, systems and computer program products for managing related documents that are held in a content management system, where the documents may be acted upon to perform workflows over those content objects.

### FIELD

This disclosure relates to shared content management systems, and more particularly to techniques for implementing document relationships within a computing system.

### BACKGROUND

The high-performance computing, storage, and networking capabilities characteristic of today's computing environments have impacted the way personal and corporate computer-readable content objects (e.g., documents, spreadsheets, images, programming code files, etc.) are created, stored, and shared. The capabilities of these environments facilitate interactions (e.g., authoring, editing, viewing, etc.) that are performed over content objects by trusted users (e.g., collaborators) on a variety of user devices such as mobile phones, tablets, laptop computers, desktop computers, and/or other devices. In many cases, commonly-occurring interactions over the content objects are organized into automated workflows. Such workflows often specify an ordered sequence or “flow” of operations to be performed on the content objects, which operations are often invoked by user interactions with the content objects. Interactions with a particular content object may be performed by one user, multiple users, and/or even autonomously by one or more computing entities (e.g., processes, agents, applications, etc.). Moreover, such interactions may span across multiple projects, and/or multiple departments, and/or multiple enterprises.

When large numbers of electronic documents are used within a collaboration ecosystem, the number of issues pertaining to how the documents are handled throughout the overall lifecycle of the document explodes.

The issue addressed in this disclosure is that, while individual documents are generally easy to manage one-by-one in isolation, there are many documents that need to be managed relative to other related documents. Conventionally, it has been a highly manual task for users or administers to perform hands-on management of related documents, to make sure that such related documents are properly handled together and not just as individual files. However, since modern content management systems now have such a large number of documents being managed by such systems, and there are so many workflows that operate over these documents, it has become increasingly and excessively difficult perform such management tasks over related documents in a manual way.

Unfortunately, needed feature developments in legacy document management systems have not kept pace with advances on collaboration system ecosystem development. Therefore, what is needed is a technique or techniques that address these deficiencies.

### SUMMARY

The present disclosure describes techniques used in systems, methods, and in computer program products for managing related documents that are held in a content management system, where the documents may be acted upon to perform workflows over those content objects.

Further details of aspects, objectives, and advantages of the technological embodiments are described herein, and in the drawings and claims.

### BRIEF DESCRIPTION OF THE DRAWINGS

The drawings described below are for illustration purposes only. The drawings are not intended to limit the scope of the present disclosure.

FIG. 1 illustrates aspects pertaining to managing related documents that are held in a content management system, where the documents may be acted upon to perform workflows over those content objects.

FIG. 2 shows a flowchart of an approach to implement some embodiments of the invention.

FIG. 3 provides a more detailed illustration of embodiments of the invention.

FIG. 4 shows a more detailed flowchart of some embodiments of the invention.

FIG. 5 provides a more detailed illustration of some embodiments of the invention.

FIG. 6 shows a flowchart according to some embodiments of the invention.

FIG. 7A and FIG. 7B present block diagrams of computer system architectures having components suitable for implementing embodiments of the present disclosure, and/or for use in the herein-described environments.

### DETAILED DESCRIPTION

Aspects of the present disclosure solve problems with managing related documents that are held in a content management system, where the documents may be acted upon to perform workflows over those content objects.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXAMPLE EMBODIMENTS

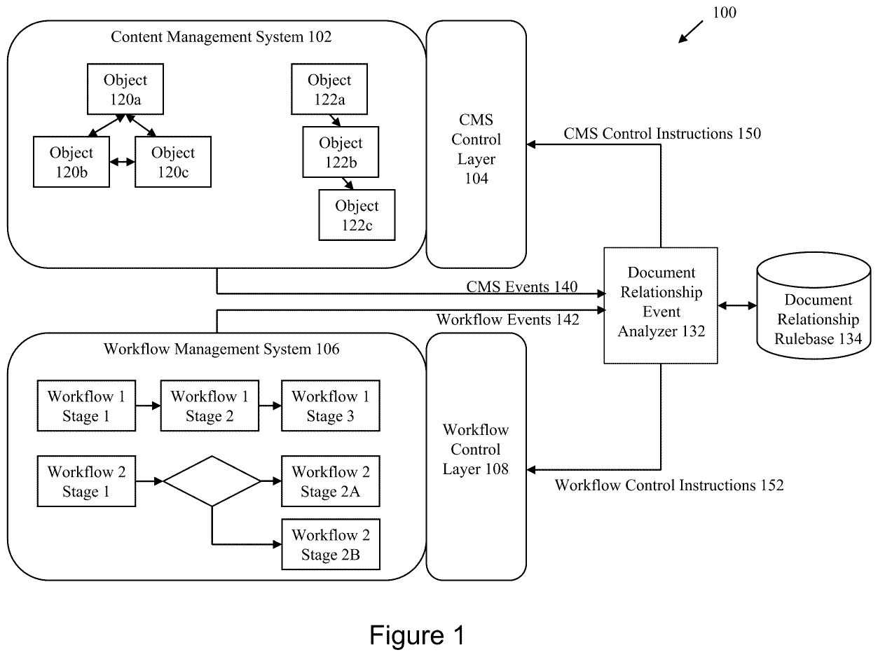

FIG. 1 illustrates a computing environment 100 in which embodiments of the present disclosure can be implemented. As an option, one or more variations of computing environment 100 or any aspect thereof may be implemented in the context of the architecture and functionality of the embodiments described herein.

FIG. 1 illustrates aspects pertaining to managing related documents that are held in a content management system, where the documents may be acted upon to perform workflows over those content objects. Specifically, FIG. 1 presents a logical depiction of how the herein disclosed techniques are used to manage related documents within a content management system.

The logical depiction of FIG. 1 depicts a representative set of content objects within a content management system 102. Such content objects may comprise a set of documents that are related to one another. Any type of relationships may be expressed by the set of documents. For example. The documents may form a parent-child type relationship, e.g., as illustrated by parent object 120a and its children objects 120b and 120c. Similarly, multi-level parent-child relationships may be formed, e.g., as shown by object 122a, child object 122b, and grand-child object 122c. Sibling relationships may also be formed, e.g., as shown between objects 120b and 120b.

A CMS control layer 104 may be provided to operate upon and interact with the content objects within the content management system 102. For example, the CM control layer 104 may be used by either users or the system itself to facilitate interactions (e.g., authoring, editing, viewing, deletion, etc.) over content objects for sharing, collaboration, and/or other purposes.

In some cases, such interactions are organized by, or implemented in conjunction with, one or more workflows from a workflow management system 106. Interactions and/or workflows over a particular content object may be performed by one or more of users and/or even autonomously by one or more computing entities (e.g., processes, agents, applications, etc.) that interact with the one or more workflows through a workflow control layer 108.

In computing environment, the interactions and/or workflows executed over content objects by users are facilitated by various applications. These applications (e.g., web apps, mobile applications, etc.) can include native applications that are provided by content management system as well as third-party applications that are available in the overall computing environment. Such third-party applications are applications that are not provided and/or maintained by the provider of content management system. Certain applications often establish direct integration with one or more other applications to extend the number and types of workflows that can be performed over content objects.

Interactions with content objects in the content management system and/or with various stages of a workflow. When interactions occur in the CMS 102, the interaction activity over the content objects are observed and recorded as CMS events 140. Similarly, when the workflow is performed, the interaction activity for the workflow is observed and recorded as workflow events 142. In some cases, the interaction activity on one may actually result in events recorded for the other. For example, a workflow action may result in the creation, modification, or deletion of a content object in the CMS, thereby resulting in a CMS event.

A document relationship event analyzer 132 is provided in system 100 to analyze the relationships between documents maintained by the CMS 102, and to take certain actions based upon these relationships. A set of rules within a document relationship rule definitions 134 may be used to control the management activities over the related documents. Application of the rules could result in a set of CMS control instructions 150 to be issued to the CMS control layer 104 to effect changes to documents at the CMS 102. Application of the rules could also result in a set of workflow control instructions 152 to be issued to the workflow control layer 108 to effect changes to one or more workflows at the workflow management system 106.

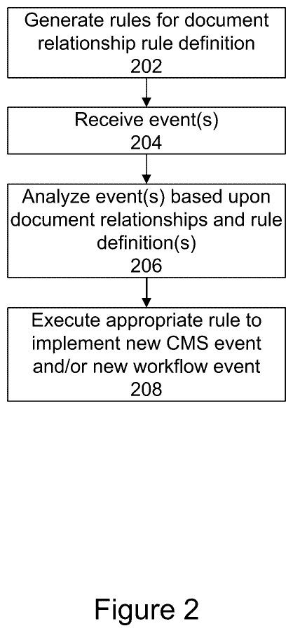

FIG. 2 illustrates a flowchart detailing an approach to implement embodiments of the invention by defining and enforcing rules that govern the relationships between digital documents.

The process begins at step 202, where one or more rules are generated and persistently stored within the document relationship rule definitions 134 (as introduced in FIG. 1). The creation of these rules is an important aspect of the invention, allowing users or system administrators to customize the behavior of the document management system based on the specific needs and interdependencies of their digital assets. The rule generation process can involve a user-friendly interface that enables the selection of trigger events, target documents based on their relationship to the trigger document, and specific actions to be performed. For instance, a rule could be defined such that when a ‘project lead’ document (the trigger) has its status changed to ‘completed’, all associated ‘task’ documents (the targets) are automatically marked as ‘closed’. These rules can also incorporate conditional logic, allowing actions to be executed only when specific criteria are met, such as a child document exceeding a certain size or a related document having a particular security classification.

Moving to step 204, the system actively monitors the computing environment 100 (as depicted in FIG. 1) for the occurrence of events that may trigger the defined relationship rules. These events, captured as either CMS events 140 or workflow events 142, represent significant activities within the document management and workflow systems. CMS events encompass a broad spectrum of direct interactions with content objects, including the creation of a new version of a document, the modification of metadata, the sharing of access permissions, or the permanent deletion of a file. Workflow events, on the other hand, reflect the progression of documents through defined business processes, such as the initiation of a review cycle, the approval of content by a designated user, or the automatic routing of a document to a specific department upon completion of an initial stage. The granularity of these monitored events can be configured to capture a wide range of user and system-initiated actions, ensuring that the rule processing engine has the necessary information to evaluate potential rule triggers.

At step 206, the document relationship event analyzer 132 plays a critical role in examining the received events in the context of established document relationships and the defined rule definitions 134. This analysis involves two key sub-processes. First, for each event, the analyzer identifies the document that was the subject of the action and queries the system's metadata or relationship database to determine if this ‘trigger document’ has any defined connections to other documents. These relationships, such as parent-child, master-detail, or peer-to-peer linkages, provide the context for potential rule application. Second, the analyzer consults the rule definitions 134 to ascertain if any existing rules are configured to be triggered by the specific type of event that has occurred on the identified document, taking into account the nature of its relationships with other documents. For example, if a document marked as a ‘master specification’ is modified, the analyzer would look for rules that specify actions to be taken on documents linked as ‘dependent components’ whenever the ‘master specification’ is updated.

Step 208 represents the core action of the invention: the execution of the appropriate rule identified in the analysis phase. When a rule is triggered by an event and the corresponding document relationships, the rule processing engine initiates the actions specified in the rule definition. This may involve generating and issuing CMS control instructions 150 to the CMS control layer 104 to directly manipulate content objects within the content management system 102.

For instance, a rule triggered by the deletion of a ‘project folder’ might result in instructions to delete all documents and subfolders contained within it. Alternatively, the rule execution might involve generating and issuing workflow control instructions 152 to the workflow control layer 108, influencing the execution of one or more workflows within the workflow management system 106. An example of this would be a rule that, upon the creation of a ‘new employee record’, automatically triggers a ‘onboarding workflow’ and associates it with the newly created document. The execution of these rules ensures the automated and consistent management of related documents, maintaining data integrity and streamlining complex document-centric processes without requiring manual intervention.

Furthermore, the system can incorporate mechanisms for logging and auditing the execution of these document relationship rules. This allows administrators to track which rules were triggered by which events, the actions that were performed on related documents, and the timestamps of these actions. Such auditing capabilities are crucial for maintaining accountability, troubleshooting any unexpected behavior, and ensuring compliance with organizational policies and regulatory requirements. The logs can provide valuable insights into the effectiveness of the defined rules and can be used to refine and optimize the rule set over time. Additionally, the system may provide features for users to review and potentially approve certain automated actions before they are executed, especially for critical or irreversible operations like deletion, offering a balance between automation and user control.

Beyond basic actions like deletion or modification, the defined rules can also trigger more complex operations. For example, a rule could specify that upon the archival of a ‘project report’, all related ‘source data’ documents are automatically moved to a long-term storage location. Another rule might dictate that when a ‘policy document’ is updated, notifications are automatically sent to all users who have previously accessed or are associated with that document. The flexibility of the rule definition module allows for the creation of sophisticated automation scenarios that can significantly enhance document lifecycle management, improve collaboration efficiency, and reduce the risk of errors associated with manual document handling in complex collaborative environments. The ability to chain rules together or define rules that trigger based on the outcome of other rules further extends the power and adaptability of the invention.

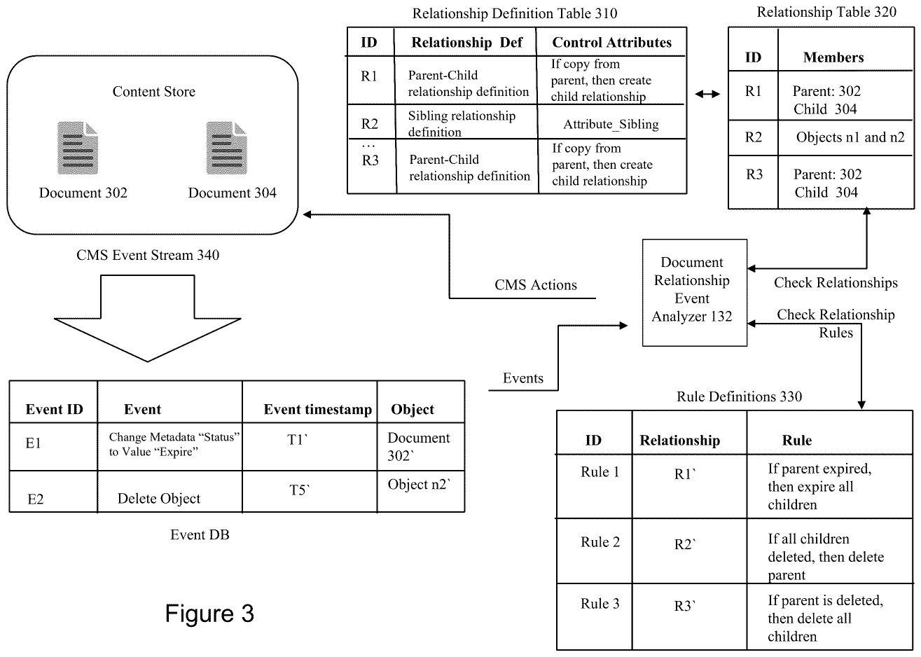

FIG. 3 provides an expanded and more granular illustration of the internal data structures that enable the embodiments of the invention, specifically focusing on how document relationships and their associated rules are defined, actively managed, and ultimately applied within the content management system.

FIG. 3 drills down into the logical organization of data that underpins the automated enforcement of document relationship rules. The example begins by highlighting the presence of at least two representative documents, document 302 and document 304, residing within the CMS 102's content store. These documents serve as tangible entities upon which the defined relationships and rules will operate, providing a concrete basis for understanding the system's functionality. It is important to note that while only two documents are shown for simplicity, the underlying data structures are designed to handle a virtually limitless number of content objects and their complex interconnections.

At the heart of the relationship management lies the relationship definition table 310. This table acts as a blueprint, defining the various semantic relationships that the system is capable of understanding and enforcing between digital documents. Each row within this table represents a type of relationship that can exist within the CMS ecosystem. The table's structure is designed for extensibility, accommodating multiple columns to capture all pertinent information about each relationship type. The “ID” column serves as a primary key, providing a unique and immutable identifier for each relationship type (e.g., “R1” for parent-child, “R2” for master-detail, “R3” for Client sibling, “R4” for related-to). This ID is crucial for referencing relationship types across other system components. The “relationship definition” column offers a more human-readable and potentially machine-interpretable description of the relationship's nature, including its inherent characteristics and implications. For instance, the definition for “parent-child” might specify a hierarchical structure where the parent typically governs certain aspects of the child's lifecycle or metadata. The “control attributes” column is particularly significant as it allows for the specification of inherent behaviors or constraints associated with each relationship type. For a “parent-child” relationship, these attributes might dictate whether permissions are inherited, how versioning is handled across the linked documents, or the default behavior upon deletion of either the parent or the child. As previously mentioned, in some sophisticated embodiments, this column might also contain pointers or direct embeddings of event rules that are intrinsically tied to the very definition of the relationship type itself.

To move from the abstract definitions to concrete instances of relationships between actual documents, the system maintains the relationship table 320. This dynamic table acts as a real-time map of how the content objects within the CMS 102 are currently interconnected. Each row in this table represents a specific instantiation of a relationship between one or more documents. Critically, this table not only identifies the involved documents but also specifies their roles within that particular relationship. For example, the first row clearly indicates that document 302 and document 304 are participating in a parent-child relationship, with an explicit designation of document 302 as the “parent” and document 304 as the “child.” This directional information is vital for correctly applying relationship-based rules. The second row illustrates a different scenario, showcasing a sibling relationship between objects conceptually labeled “n1” and “n2.” The system dynamically maintains this table by referencing the relationship definition table 310. When a user or a system process establishes a new link between documents and specifies the type of relationship (referencing an “ID” from the relationship definition table), a new entry is created in the relationship table 320, recording the participating documents and their respective roles. Conversely, when relationships are broken or documents are removed, the relationship table is updated accordingly, ensuring its accuracy as a “living document” reflecting the current state of document interdependencies.

Complementing the relationship management framework is the rules definition table 330, which serves as the repository for the specific rules that govern how events impacting documents within a relationship should be automatically handled. Each row in this table encapsulates a distinct rule, defining a trigger condition (typically an event occurring to a document in a specific role within a relationship) and a corresponding action to be taken on related documents. The “ID” column provides a unique identifier for each rule, facilitating its internal management and potential referencing. The “relationship” column acts as a crucial link, specifying the particular type of relationship (by referencing the “ID” from the relationship definition table 310) to which this rule is applicable. This ensures that rules are only considered for events involving documents that participate in the designated type of relationship. The “rule” column contains the core logic of the rule itself. This might be expressed in a structured format (e.g., using a rule engine syntax) or as a more descriptive text that the system can parse and execute. The rule definition will typically specify the triggering event (e.g., “document deleted,” “status changed to ‘expired’”), the conditions under which the rule should be applied (which might involve specific document metadata or the roles of the related documents), and the action to be performed on the target document(s) within the relationship (e.g., “delete child documents,” “change status to ‘obsolete’,” “send notification to owner”).

To illustrate the power and flexibility of the rules definition table 330, consider the provided examples in more detail. The first rule, associated with the parent-child relationship (“R1”), dictates that if a parent document's status transitions to “expired,” an automated action is triggered to also set the status of all its associated child documents to “expired.” This ensures consistency and reflects the hierarchical dependency between the documents. The second rule, potentially also related to the parent-child relationship, outlines a condition-based action: only if all child documents of a parent have been deleted is it then permissible for the system to allow or even automatically initiate the deletion of the parent document. This rule helps maintain data integrity by preventing the accidental deletion of a parent while its dependent children still exist. The third example directly addresses the initial scenario of cascading deletion: if a parent object is deleted, the rule mandates that all its linked child objects must also be automatically deleted, preventing the creation of orphaned and potentially inaccessible child documents. These examples demonstrate the ability to define rules based on various events (status change, deletion), conditions (all children deleted), and actions (status update, deletion), all tied to specific relationship types.

The dynamic interplay between these data structures and the real-time activity within the CMS is orchestrated by the event stream 340 and the document relationship event analyzer 132. As users interact with documents or as automated processes modify them, the CMS 102 generates a continuous stream of events, each detailing the type of action, the affected document(s), and relevant metadata. This event stream 340 acts as the sensory input for the document relationship event analyzer 132. Upon receiving an event, the event analyzer's first crucial step is to consult the relationship table 320 to determine if the document involved in the event (the potential “trigger document”) participates in any defined relationships. This lookup allows the system to identify if the event has the potential to trigger any relationship-based rules. If the document is indeed part of one or more relationships, the event analyzer then proceeds to the rules definition table 330. Here, it searches for rules that are specifically associated with the type of relationship(s) the affected document is part of and that are also configured to be triggered by the type of event that has occurred.

The final stage involves the execution of any applicable rules identified by the document relationship event analyzer 132. When a match is found between an event, the document's relationships (as defined in the relationship table 320), and a rule (as defined in the rules definition table 330), the analyzer initiates the actions specified in the “rule” column of the rules definition table. This execution might involve generating commands to the CMS control layer 104 (as seen in FIG. 1) to perform actions directly on content objects, such as deleting, modifying metadata, changing permissions, or altering the status of related documents. Alternatively, the rule execution might involve interactions with the workflow management system 106 (again, from FIG. 1), such as triggering new workflow instances for related documents, updating the state of existing workflows, or assigning tasks based on the event and the defined relationships. This automated execution of rules, driven by the structured data in the relationship definition table 310, the relationship table 320, and the rules definition table 330, is what enables the system to intelligently and autonomously manage the complex interdependencies between digital documents, ensuring consistency, data integrity, and operational efficiency within the content management ecosystem.

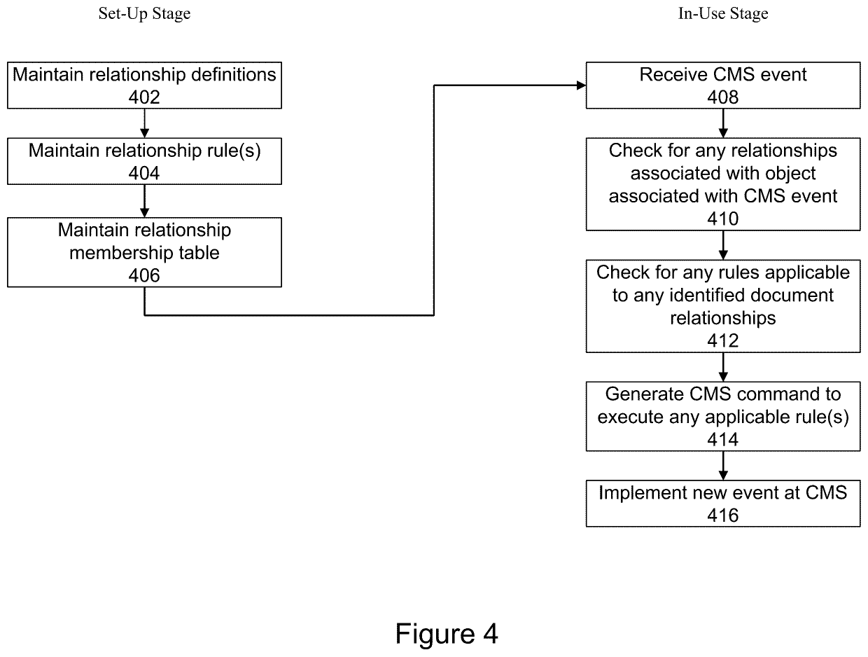

FIG. 4 provides an even more granular and detailed flowchart that outlines the distinct operational phases of the invention, specifically delineating a crucial set-up stage and a dynamic in-use phase. This flowchart serves to elucidate the precise sequence of actions and data interactions that enable the automated management of document relationships and the enforcement of associated rules within the content management ecosystem.

The initial set-up stage, as depicted in the left portion of the flowchart, is a foundational phase that establishes the necessary framework for the invention to operate effectively. This stage typically occurs during the initial configuration of the system, when new types of document relationships are being defined, or when the rules governing these relationships are being established or modified. It comprises three critical maintenance operations that ensure the system possesses the knowledge and structure to manage document interdependencies.

At step 402, the maintenance of relationship definitions is undertaken. This involves a deliberate and structured process of populating and continuously managing the relationship definition table 310, as previously detailed in the context of FIG. 3. During this step, authorized users or system administrators define the semantic relationships that the system will recognize and be capable of enforcing between digital documents. Each defined relationship type, such as the hierarchical “parent-child,” the primary-secondary “master-detail,” the peer-level “sibling,” or the general “related-to,” is assigned a unique identifier. Furthermore, the inherent characteristics and implications of each relationship type are defined, often including specifying default behaviors or constraints associated with the linkage. For instance, the definition of a “parent-child” relationship might include attributes indicating whether access permissions are inherited from the parent, how versioning is synchronized between related documents, or the default actions to be taken upon the deletion or modification of either the parent or the child. This step is crucial for establishing a clear and consistent understanding of document interconnections within the system.

Following the definition of relationship types, step 404 focuses on the maintenance of relationship rules. This involves the detailed specification and storage of the rules within the rules definition table 330, as elaborated in FIG. 3. These rules are the core logic that dictates how the system will automatically respond to events occurring to documents that participate in the previously defined relationships. For each rule, administrators must specify the precise triggering event (e.g., a document being created, deleted, modified, accessed, or its status changing), any specific conditions that must be met for the rule to be applied (which might involve examining document metadata, user roles, or the state of related documents), and the exact action that should be performed on the target document(s) within the relationship. Critically, each rule is explicitly linked to one or more of the relationship types defined in step 402, ensuring that the rule is only considered when an event involves documents participating in the designated type of relationship. This step allows for the customization of the system's behavior to align with specific organizational workflows and data management policies.

The final maintenance step in the set-up phase, step 406, involves the ongoing management of the relationship membership table 320, as described in FIG. 3. This table serves as the dynamic registry of the actual instances of relationships that exist between specific content objects within the CMS 102. As users establish new links between documents, or as system processes create or modify relationships, entries are added or updated in this table. Each entry not only identifies the participating documents but also explicitly defines their roles within that particular relationship instance (e.g., specifying which document is the parent and which is the child in a parent-child relationship). This table is continuously updated to accurately reflect the current network of document interdependencies within the CMS. The information stored in this table is crucial for the in-use phase, as it allows the system to quickly determine which documents are related to a document that has been the subject of an event.

Once the foundational data structures and rules are established during the set-up phase, the system transitions into the dynamic in-use phase, depicted in the right-side portion of the flowchart. This is where the system actively monitors and responds to events occurring within the content management system, automatically enforcing the defined relationship rules.

The in-use phase begins at step 408 with the reception of a CMS event by the document relationship event analyzer 132 (as introduced in FIG. 1). This event signifies any significant action that has been performed on a content object within the CMS 102. The event carries information about the specific document that was acted upon, the type of action that occurred (e.g., a user deleted a document, a system process updated metadata, a workflow changed the status of a file), and potentially other relevant details such as the user who initiated the action and the timestamp of the event. This event stream provides the real-time input that drives the automated rule enforcement process.

Upon receiving a CMS event, the system proceeds to step 410, where a crucial check is performed to determine if the document that was the subject of the event (now acting as a potential ‘trigger object’) is currently participating in any defined relationships. This is achieved by querying the relationship membership table 320. The system examines the entries in this table to see if the identifier of the subject object matches any of the participating document identifiers. If a match is found, the system retrieves information about the relationship(s) the subject object is involved in, including the type of relationship (by referencing the relationship definition table 310) and the identifiers of the other documents that are related to the subject object within those specific relationship instances.

Following the identification of any relationships involving the subject object at step 410, the system proceeds to a critical decision-making stage at step 412: checking for any applicable rules within the rules definition table 330. This step involves a sophisticated process of matching the current context—the type of CMS event that has occurred and the specific type(s) of relationship that the affected document is a part of—against the rules that have been previously defined and stored. The document relationship event analyzer 132 plays a key role here. It iterates through the rules stored in the rules definition table, examining the ‘relationship’ column to identify rules that are associated with the same type of relationship(s) that the subject object is currently involved in. For each of these relationship-specific rules, the analyzer then scrutinizes the ‘rule’ column to determine if the triggering event specified in the rule matches the type of CMS event that has just been received at step 408. This matching process might involve exact matches (e.g., a rule triggered by ‘document deleted’ only being considered when a ‘document deleted’ event occurs) or more nuanced comparisons, potentially taking into account specific event parameters or document metadata if the rule definition includes such conditions. For instance, a rule might specify “if a parent document with status ‘active’ is deleted,” requiring the analyzer to not only check for a ‘document deleted’ event but also to verify the ‘active’ status of the deleted document before considering the rule applicable. Furthermore, the analyzer might need to consider the role of the affected document within the relationship. A rule might only apply if the deleted document was the ‘parent’ in a parent-child relationship. This multi-faceted matching process ensures that only the rules that are precisely relevant to the current event and the specific document relationships are considered for execution, preventing unintended or erroneous automated actions.

If the comprehensive analysis at step 412 identifies one or more applicable rules that precisely match the occurred event and the relationships of the affected document (and potentially any specified conditions within the rule), the system proceeds to step 414: generating CMS commands. This step involves translating the abstract logic of the triggered rule(s) into concrete, actionable instructions that the CMS control layer 104 can understand and execute to manipulate the content objects within the CMS 102. The document relationship event analyzer 132, based on the triggered rule and the information retrieved from the relationship membership table 320 about the related documents, constructs these CMS commands. The nature of the generated commands is entirely dependent on the ‘action’ specified within the triggered rule. For a rule stating “if a parent document is deleted, then delete all its child documents,” the command generation process would involve identifying all the child documents associated with the deleted parent (by querying the relationship membership table) and creating a series of ‘delete document’ commands, each targeting one of those child document identifiers. Similarly, for a rule that dictates “if a master document is updated, then update the ‘revision number’ metadata of all its detail documents,” the command generation would involve identifying the linked detail documents and creating ‘modify metadata’ commands for each, setting their ‘revision number’ to a value derived from the updated master document. The generated commands are typically structured in a format that the CMS control layer's API or internal communication protocols can readily interpret and execute. This step ensures that the intent of the defined rule is translated into tangible actions within the document management system. In scenarios where multiple applicable rules are triggered by a single event, the system might employ a prioritization mechanism (either implicitly based on the order of rules or explicitly defined) to determine the sequence in which the corresponding CMS commands are generated and subsequently executed.

The final step in the in-use phase, step 416, involves the execution of the CMS commands that were generated at step 414. These commands are transmitted to the CMS control layer 104, which acts as the intermediary responsible for interacting directly with the core content management system 102 and its underlying data store. The CMS control layer receives these commands and orchestrates the necessary operations to modify the affected content objects as instructed. For instance, upon receiving a ‘delete document’ command for a specific child document, the CMS control layer would initiate the process of removing that document from the file system or database where the content is stored, updating relevant metadata and access permissions as necessary. Similarly, for ‘modify metadata’ commands, the control layer would locate the specified documents and update their associated metadata fields with the provided values. The execution of these commands is typically performed with the same level of security and transactional integrity as any other user-initiated or system-driven action within the CMS. The CMS control layer might also generate its own internal events or log entries to record the execution of these rule-driven commands, contributing to the overall system audit trail. This final step effectively realizes the automated enforcement of the defined document relationship rules, ensuring that the intended cascading actions or updates on related documents are carried out seamlessly and consistently in response to events occurring within the content management system, thereby maintaining the integrity and coherence of the managed digital assets.

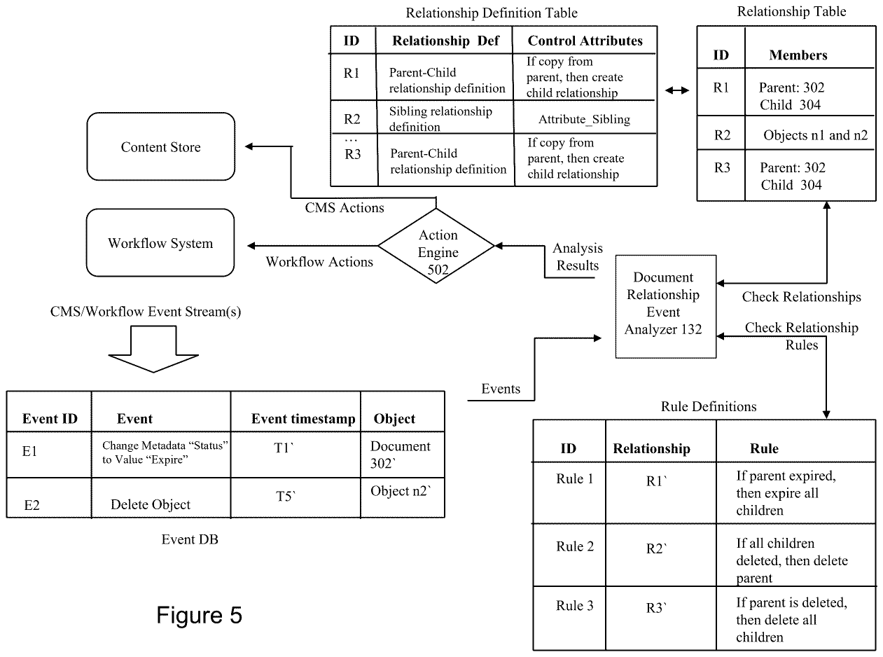

FIG. 5 provides a more detailed illustration of an alternative embodiment of the invention, emphasizing the system's capability to orchestrate actions across both the Content Management System (CMS) 102 and the Workflow Management System 106 in response to events and document relationship rules. In this embodiment, the events that are identified and analyzed can serve as triggers for generating actions that directly manipulate content and metadata within the CMS, as well as initiate or modify processes and tasks within the workflow system, showcasing a more integrated and comprehensive approach to managing document lifecycles and related processes.

As discussed in the context of previous figures, a relationship definition table 310 remains a fundamental component, serving to define the various types of relationships that can exist between documents and other objects managed by the CMS 102. Each row within this table delineates a distinct relationship type, and the table's structure, with its multiple columns, allows for the comprehensive expression of all relevant attributes and characteristics associated with each defined relationship.

Similarly, a relationship table 320 continues to be maintained as the dynamic registry of the active instances of relationships between specific content objects within the CMS 102. This table, as previously noted, is not a static inventory but a constantly evolving record that reflects the current interconnections between documents based on the defined relationship types and the ongoing activities within the system. Its ability to be continually updated ensures that the system always has an accurate understanding of how documents are related at any given time.

The rules definition table 330 also persists as the central repository for the rule definitions that govern the system's automated responses to events occurring within the context of document relationships. Each row in this table defines a specific rule, and the table's structure, including columns for a unique rule ID, the associated relationship type (referencing the relationship definition table), and the detailed specification of the rule itself (including triggering events, conditions, and actions), remains consistent with the descriptions in earlier figures.

In this enhanced embodiment, the event stream that feeds into the document relationship event analyzer 132 can originate from either or both the CMS 102 and the Workflow Management System 106. This allows the system to react not only to direct manipulations of content objects within the CMS but also to the progression and events occurring within automated workflows that involve these documents. The document relationship event analyzer 132 performs the crucial task of examining the events from this unified or separate event stream, checking whether the document referenced in the event participates in any defined relationships (by querying the relationship table 320). If a relationship is found, the analyzer then consults the rules definition table 330 to determine if there is an applicable rule for that specific relationship type and the type of event that has occurred. If a matching rule is identified, the analyzer flags this rule and the relevant information for subsequent action.

A key addition in this embodiment, as illustrated in FIG. 5, is the introduction of an action engine 502. The action engine 502 stands as a pivotal orchestrator within the system, acting as the central processing unit for translating the insights gleaned from the document relationship event analyzer 132 into tangible actions within the digital ecosystem. The analyzer's output, detailing triggered rules, affected trigger documents, identified target documents based on their relationships, and the specifics of the initiating event, serves as the foundational intelligence upon which the action engine operates. Unlike the passive analysis performed by the event analyzer, the action engine is inherently active, responsible for making decisions about “what” actions to take, “which” system (CMS 102, Workflow Management System 106, or both) should execute these actions, and “how” these actions should be formulated as specific commands.

When the action engine 502 determines that a triggered rule necessitates a direct manipulation of content or metadata within the CMS 102, its primary responsibility is the generation of CMS control instructions 150. This process involves a precise mapping between the abstract action defined in the ‘rule’ column of the rules definition table 330 and the concrete commands understood by the CMS control layer 104. The action engine leverages the information stored in the relationship membership table 320 to accurately identify the target content objects that need to be acted upon. For instance, if a rule dictates that upon the modification of a ‘source document’, all linked ‘derivative documents’ should have their ‘status’ metadata updated to ‘outdated’, the action engine would first query the relationship membership table to find all documents related to the modified ‘source document’ via the specified ‘derivative’ relationship. It would then generate a series of ‘modify metadata’ commands, each targeting one of these ‘derivative documents’ and specifying the update of the ‘status’ field to ‘outdated’. The complexity here can extend to handling different versions of documents, ensuring that actions are applied to the correct iterations, and managing potential conflicts if multiple rules trigger actions on the same document. The action engine must also be cognizant of the security context under which these automated actions are performed, ensuring that it operates with the necessary permissions to modify the targeted content objects.

In scenarios where the triggered rules necessitate interaction with the Workflow Management System 106, the action engine 502 undertakes the task of generating appropriate workflow control instructions 152. This involves understanding the available workflows within the system, their initiation parameters, and the commands required to modify their state or trigger specific transitions. For example, if a rule is activated by the ‘submission’ of a ‘contract document’ to the CMS and specifies the initiation of a ‘legal review workflow’, the action engine would construct a ‘start workflow’ command, identifying the ‘legal review workflow’ definition and associating it with the newly submitted ‘contract document’ (using its unique CMS identifier). Furthermore, the action engine might need to extract relevant data from the CMS event or the ‘contract document’ itself (such as the submitting user, the contract value, or the involved parties) and include this data as parameters when initiating the workflow. This ensures that the workflow starts with the necessary context. Similarly, if a rule dictates that upon the ‘rejection’ of a document within a workflow, a notification email should be sent to the document owner, the action engine would generate a ‘send notification’ command, specifying the recipient's email address (potentially retrieved from the document's metadata or a user directory), the content of the email, and any relevant attachments. The action engine acts as a bridge between the event-driven logic of the CMS and the process-oriented nature of the workflow system.

To effectively translate the diverse rules into specific system commands, the action engine 502 often incorporates a sophisticated mapping and transformation layer. This layer might utilize a configuration database or a set of predefined templates that associate specific rule actions with the corresponding CMS and workflow control layer commands. For instance, a generic rule action like ‘update status’ might be mapped to different CMS metadata update commands depending on the specific document type or metadata schema, and it might be mapped to different workflow state transition commands depending on the active workflow and its defined states. This mapping layer provides the flexibility to adapt the system's behavior to different CMS and workflow platforms and to accommodate evolving business requirements. The action engine might also perform data type conversions or data formatting to ensure compatibility between the data provided by the event analyzer and the data structures expected by the CMS and workflow control layers.

Beyond simply generating commands, the action engine 502 often incorporates mechanisms for ensuring the reliability and robustness of the automated actions. This can include implementing error handling routines to manage situations where a command fails to execute (e.g., due to network issues, permission errors, or invalid data). The action engine might also employ retry mechanisms, attempting to re-execute failed commands a certain number of times before escalating the issue or logging an error. Maintaining a comprehensive audit trail of all initiated actions is another critical function of the action engine. This log typically records the triggered rule, the triggering event, the target documents, the generated commands, the timestamps of execution, and the success or failure status of each action. This audit trail is invaluable for monitoring the system's behavior, troubleshooting any unexpected outcomes, and ensuring compliance with regulatory requirements. In more advanced implementations, the action engine might also support transactional behavior, ensuring that a series of related CMS and workflow actions are treated as a single atomic unit, where all actions succeed or all are rolled back in case of a failure, maintaining data consistency across the integrated systems.

Furthermore, the action engine 502 might be designed with extensibility in mind, allowing for the integration of new types of actions and interactions with other external systems beyond the core CMS and workflow platforms. This could involve the ability to trigger calls to external APIs, send messages to messaging queues, or interact with other enterprise applications based on defined document relationship rules and events. This extensibility would significantly enhance the system's ability to automate complex, cross-platform business processes that are triggered by events within the document management ecosystem. The configuration of these external integrations would likely be managed through the rules definition table or a related configuration interface, allowing administrators to define sophisticated automation workflows that extend far beyond the boundaries of the core CMS and workflow systems.

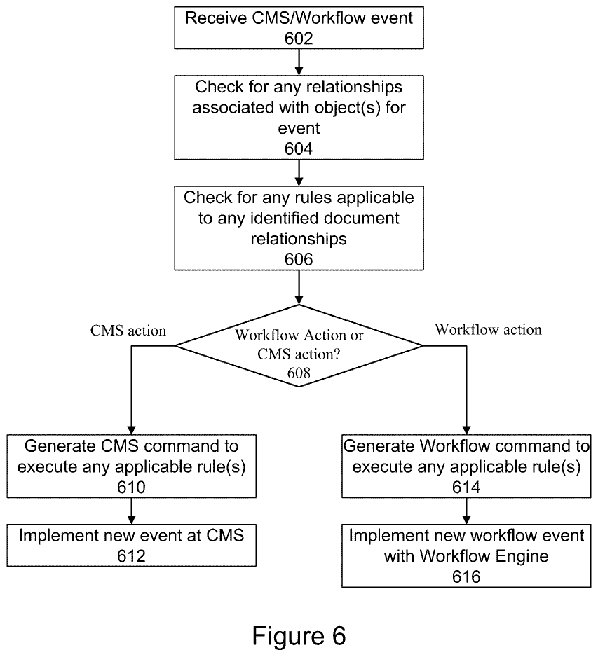

FIG. 6 illustrates a comprehensive flowchart that encapsulates the core operational logic of some embodiments of the invention. It provides a granular view of how the system intelligently responds to a multitude of events originating from both the content repository managed by the Content Management System (CMS) 102 and the automated processes orchestrated by the Workflow Management System 106. The flowchart traces the path from the initial reception of an event to the potential execution of coordinated actions across these interconnected systems, all driven by the pre-defined rules that govern the relationships between digital documents.

The process commences at step 602 with the system's attentive reception of one or more events. These events serve as the initial triggers that set the entire rule enforcement mechanism in motion. The events can be diverse in nature, reflecting the myriad interactions and state changes that occur within the digital environment. CMS events 140 might signal a user creating a new document, modifying the content of an existing one, altering its associated metadata (such as author, creation date, or status), changing access permissions, moving or copying files, or even permanently deleting content. Conversely, workflow events 142 indicate significant milestones or transitions within automated business processes. These could include the initiation of a workflow instance, the completion of a specific task by a user, the approval or rejection of a document at a particular stage, the triggering of a timer, or the invocation of an external service by the workflow engine. The system's ability to ingest and process this broad spectrum of events ensures a holistic and context-aware response to activities across the document lifecycle and related business processes.

Upon the receipt of an event at step 602, the system proceeds to a critical investigative phase at step 604, where a thorough check is performed to ascertain if the object(s) implicated in the event are participants in any established relationships. For a CMS event, this involves the document relationship event analyzer 132 identifying the specific document that was created, modified, deleted, or otherwise acted upon. The analyzer then interrogates the relationship membership table 320, which, as previously described, serves as the dynamic registry of all active document relationships within the CMS. This query aims to determine if the identified ‘trigger object’ is listed as either a source or a target in any existing relationship entries. Similarly, for a workflow event that pertains to a specific document (e.g., a document progressing to a new stage in a review workflow), the analyzer again consults the relationship membership table to uncover any defined connections this document might have with other content objects within the CMS. The outcome of this step is the potential identification of one or more relationships of various types (parent-child, sibling, master-detail, etc.) in which the trigger object actively participates, thus establishing the context for potential rule application.

Following the identification of any relevant relationships at step 604, the system advances to a crucial decision-making juncture at step 606: a check is made to determine whether any rules, stored within the rules definition table 330, are applicable to the identified document relationship(s) in light of the received event. This involves a sophisticated matching process orchestrated by the document relationship event analyzer 132. The analyzer examines the rules definition table, filtering for rules that are specifically associated with the types of relationships identified in the previous step. For each of these relationship-specific rules, the analyzer then scrutinizes the rule's definition to ascertain if its specified triggering event aligns with the type of CMS or workflow event that was received at step 602. This matching can involve precise comparisons of event types and might also extend to evaluating specific conditions embedded within the rule's definition, such as examining document metadata values or user roles associated with the event. Only those rules whose relationship type matches the identified relationship(s) and whose triggering event (and any associated conditions) are satisfied by the received event are deemed applicable. If one or more such applicable rules are found, the process proceeds to step 608.

At step 608, the action engine 502 takes center stage to determine whether any concrete actions should be generated as a direct consequence of the triggered rule(s) identified in the preceding step. This determination is based on a detailed analysis of the ‘action’ specifications within the applicable rule(s). A single event might trigger multiple rules, and a single rule might specify a series of actions to be taken, potentially involving both the CMS and the workflow system. The action engine carefully evaluates the nature of these prescribed actions. CMS-related actions might involve modifications to the content or metadata of specific documents, the deletion or movement of files, alterations to access control lists or permissions, or changes to the status or lifecycle stage of a content object within the repository. Workflow-related actions, on the other hand, could include initiating new workflow instances, advancing the current stage of an active workflow, assigning tasks to specific users or groups, sending automated notifications (via email or other communication channels), triggering the invocation of external services or applications, or even terminating a running workflow instance. The action engine acts as an intelligent planner, deciding which of these types of actions, if any, need to be formulated and directed towards the appropriate system(s). [0006] If the action engine 502 determines at step 608 that CMS actions are required based on the triggered rule(s), the process branches to step 610. Here, the action engine generates specific CMS commands 150 that are designed to instruct the CMS control layer 104 to perform the necessary manipulations on the content objects within the CMS 102. The generation of these commands is a precise process that takes into account the target documents (identified via the relationship membership table 320), the specific action defined in the rule, and the syntax or API calls understood by the CMS control layer. For instance, if a rule dictates the deletion of child files upon the deletion of a parent file, the action engine would generate a series of ‘delete document’ commands, each containing the unique identifier of a child document linked to the deleted parent. The action engine ensures that these commands are correctly formatted and include all necessary parameters for the CMS control layer to execute them accurately. Following the generation of these commands, the process moves to step 612, where the CMS control layer 104 receives and executes these instructions, thereby implementing the initial triggering event's consequences along with the automated actions dictated by the relationship rule within the CMS repository.

In parallel or as an alternative to generating CMS actions, if the action engine 502 determines at step 608 that workflow actions are necessary, the process branches to step 614. At this stage, the action engine formulates specific workflow commands 152 that are intended for the workflow control layer 108, which manages the Workflow Management System 106. These commands are tailored to interact with the workflow engine and can encompass a wide range of operations. For example, a rule triggered by a parent document receiving a digital signature might necessitate the initiation of a signature workflow for its child documents. In such a case, the action engine would generate ‘start workflow’ commands, specifying the appropriate signature workflow definition and associating it with each of the child documents (identified through the relationship membership table), potentially also passing along relevant data such as the document identifiers and the list of required signatories. Subsequently, at step 616, the workflow control layer 108 receives and executes these workflow commands, thereby implementing the rule's requirements within the workflow management system. This might involve creating new workflow instances, advancing the state of existing workflows, assigning tasks to users, sending notifications via the workflow engine, or triggering integrations with external services (like a third-party signature service). It is crucial to note the bidirectional interaction: a CMS action triggered by a rule can itself initiate a new workflow or trigger a specific action within an already active workflow, highlighting the intricate interplay between content and process management.

It is noted that a fundamental aspect of some embodiments of the invention is the ‘first-class’ nature of the actions performed based on relationship rules. This signifies that the consequences of a rule-driven action are not isolated events but are fully integrated into the system's event processing pipeline. For instance, if a document is automatically deleted as a result of a parent deletion rule, and that deleted document was itself the parent in another relationship governed by its own set of rules (e.g., a rule stating that the deletion of a parent should trigger a notification to its collaborators), the system will recognize the deletion of this intermediate document as a new event. This new event will then be subjected to the same process of relationship checking and rule evaluation, potentially leading to a cascade of further automated actions. This recursive or iterative behavior ensures a comprehensive and consistent enforcement of relationship rules across multiple levels of document dependencies and hierarchies, preventing the creation of inconsistencies or orphaned data throughout the entire content management ecosystem.

Therefore, what has been described is an improved approach for managing related documents that are held in a content management system, where the documents may be acted upon to perform workflows over those content objects.

The invention addresses the concrete technical challenge of automatically maintaining the integrity and consistency of related digital documents within complex computing environments characterized by numerous documents and automated workflows. This is achieved through a specific technological solution involving the creation and manipulation of dedicated data structures, namely relationship definition tables, relationship membership tables, and rules definition tables, coupled with the integration of a document relationship event analyzer and an action engine. These components work in concert to actively process events and generate precise commands for both content management and workflow systems, enabling a level of automated, relationship-aware functionality that surpasses prior art manual methods or generic data management systems lacking this specific capability. This integrated system provides a tangible and non-abstract means of managing document interdependencies, leading to demonstrable technological benefits such as enhanced efficiency, reduced errors, and improved data governance.

Furthermore, the invention is substantiated by its implementation of a specific and non-conventional technological process. The automated analysis of events within the context of defined document relationships, followed by the triggering of specific, pre-defined actions across distinct computing systems (CMS and workflow), represents a concrete application of computer technology tailored to solve a domain-specific problem. This constitutes a bespoke technological solution that leverages specifically designed software components and data management techniques to achieve a practical and useful outcome in the field of digital document management. The novelty and non-obviousness inherent in the specific implementation details, encompassing the structure of the relationship and rule tables, the operational logic of the event analyzer and action engine, and the coordinated generation of CMS and workflow commands, further demonstrating a specific, inventive application of technology to a recognized technical problem within the art.

Finally, the invention provides tangible technical improvements over existing solutions. Traditional document management systems often lack the sophisticated mechanisms to define and automatically enforce complex, relationship-driven behaviors. This invention provides a specific technological mechanism to address this critical deficiency, resulting in demonstrable advancements such as enhanced data integrity through consistent actions across related documents, increased operational efficiency by automating tasks previously requiring manual intervention, improved regulatory compliance by automatically enforcing policies on interconnected document sets, and more streamlined business workflows by triggering process changes based on document relationships. These are concrete and measurable improvements within the technical field of document management, directly attributable to the specific implementation details of the invention's unique data structures and processing logic. The system's capability to manage cascading actions based on rule triggers further exemplifies its technical sophistication and its departure from the limitations of more basic document management automation techniques.

### System Architecture Overview

### Additional System Architecture Examples

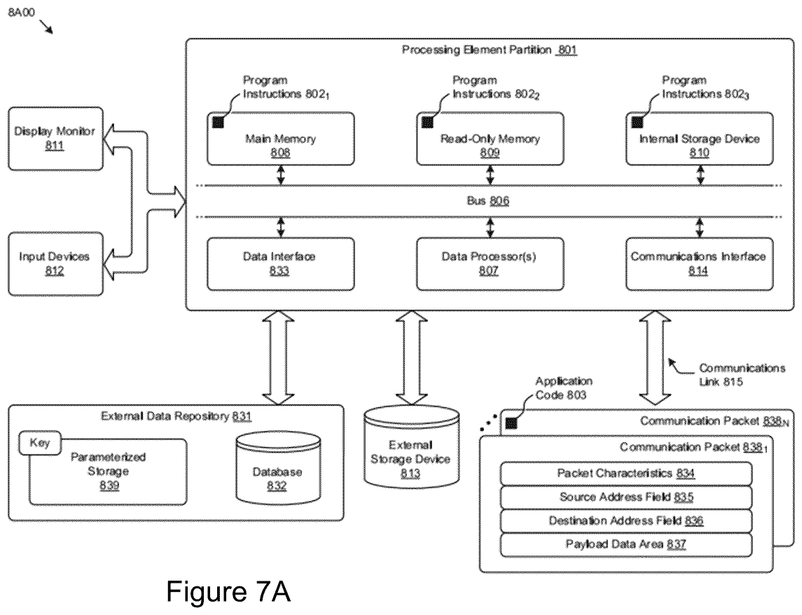

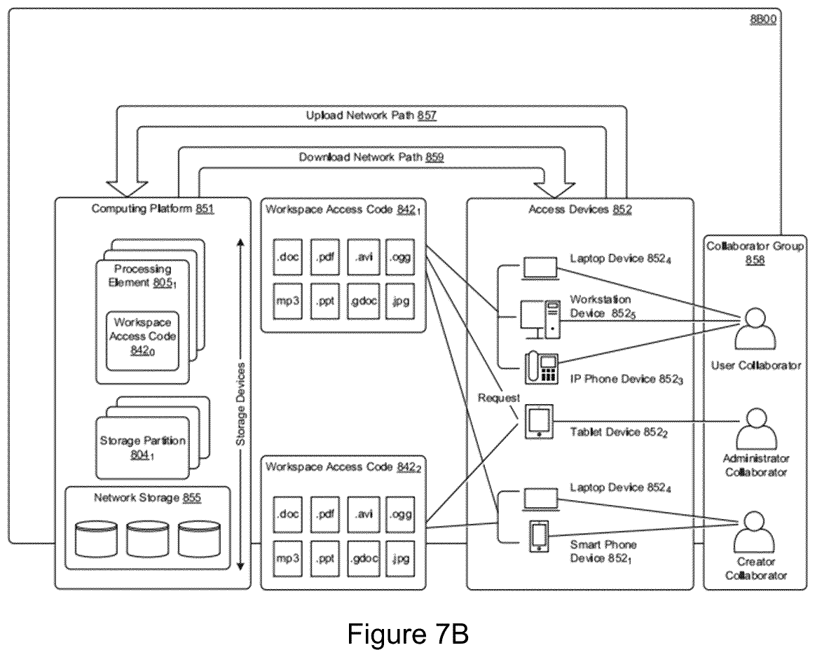

FIG. 7A depicts a block diagram of an instance of a computer system 8A00 suitable for implementing embodiments of the present disclosure. Computer system 8A00 includes a bus 806 or other communication mechanism for communicating information. The bus interconnects subsystems and devices such as a central processing unit (CPU), or a multi-core CPU (e.g., data processor 807), a system memory (e.g., main memory 808, or an area of random access memory (RAM)), a non-volatile storage device or non-volatile storage area (e.g., read-only memory 809), an internal storage device 810 or external storage device 813 (e.g., magnetic or optical), a data interface 833, a communications interface 814 (e.g., PHY, MAC, Ethernet interface, modem, etc.). The aforementioned components are shown within processing element partition 801, however other partitions are possible. Computer system 8A00 further comprises a display 811 (e.g., CRT or LCD), various input devices 812 (e.g., keyboard, cursor control), and an external data repository 831.

According to an embodiment of the disclosure, computer system 8A00 performs specific operations by data processor 807 executing one or more sequences of one or more program instructions contained in a memory. Such instructions (e.g., program instructions 802₁, program instructions 802₂, program instructions 802₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 8A00 performs specific networking operations using one or more instances of communications interface 814. Instances of communications interface 814 may comprise one or more networking ports that are configurable (e.g., pertaining to speed, protocol, physical layer characteristics, media access characteristics, etc.) and any particular instance of communications interface 814 or port thereto can be configured differently from any other particular instance. Portions of a communication protocol can be carried out in whole or in part by any instance of communications interface 814, and data (e.g., packets, data structures, bit fields, etc.) can be positioned in storage locations within communications interface 814, or within system memory, and such data can be accessed (e.g., using random access addressing, or using direct memory access DMA, etc.) by devices such as data processor 807.

Communications link 815 can be configured to transmit (e.g., send, receive, signal, etc.) any types of communications packets (e.g., communication packet 838₁, communication packet 838_{N}) comprising any organization of data items. The data items can comprise a payload data area 837, a destination address 836 (e.g., a destination IP address), a source address 835 (e.g., a source IP address), and can include various encodings or formatting of bit fields to populate packet characteristics 834. In some cases, the packet characteristics include a version identifier, a packet or payload length, a traffic class, a flow label, etc. In some cases, payload data area 837 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 807 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 831, which in turn can be formatted into any one or more storage areas, and which can comprise parameterized storage 839 accessible by a key (e.g., filename, table name, block address, offset address, etc.).

Execution of the sequences of instructions to practice certain embodiments of the disclosure are performed by a single instance of a computer system 8A00. According to certain embodiments of the disclosure, two or more instances of computer system 8A00 coupled by a communications link 815 (e.g., LAN, public switched telephone network, or wireless network) may perform the sequence of instructions required to practice embodiments of the disclosure using two or more instances of components of computer system 8A00.

Computer system 8A00 may transmit and receive messages such as data and/or instructions organized into a data structure (e.g., communications packets). The data structure can include program instructions (e.g., application code 803), communicated through communications link 815 and communications interface 814. Received program instructions may be executed by data processor 807 as it is received and/or stored in the shown storage device or in or upon any other non-volatile storage for later execution. Computer system 8A00 may communicate through a data interface 833 to a database 832 on an external data repository 831. Data items in a database can be accessed using a primary key (e.g., a relational database primary key).

Processing element partition 801 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 807. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to accessing a dynamically extensible set of content object workflows. A module may include one or more state machines and/or combinational logic used to implement or facilitate the operational and/or performance characteristics pertaining to accessing a dynamically extensible set of content object workflows.

Various implementations of database 832 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of accessing a dynamically extensible set of content object workflows). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations that pertain to accessing a dynamically extensible set of content object workflows, and/or for improving the way data is manipulated when performing computerized operations pertaining to accessing a dynamically extensible set of applications through a content management system to perform workflows over content objects managed by the content management system.

FIG. 7B depicts a block diagram of an instance of a cloud-based environment 8B00. Such a cloud-based environment supports access to workspaces through the execution of workspace access code (e.g., workspace access code 842₀, workspace access code 842₁, and workspace access code 842₂). Workspace access code can be executed on any of access devices 852 (e.g., laptop device 852₄, workstation device 852₅, IP phone device 852₃, tablet device 852₂, smart phone device 852₁, etc.), and can be configured to access any type of object. Strictly as examples, such objects can be folders or directories or can be files of any filetype. A group of users can form a collaborator group 858, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 851, including in a middleware setting. As shown, a portion of the workspace access code resides in and can be executed on one or more processing elements (e.g., processing element 805₁). The workspace access code can interface with storage devices such as networked storage 855. Storage of workspaces and/or any constituent files or objects, and/or any other code or scripts or data can be stored in any one or more storage partitions (e.g., storage partition 804₁). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 857). A stored workspace can be delivered to a particular user and/or shared with other particular users via a download (e.g., a download from a processing element to an access device over a download network path 859).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A method, comprising:
identifying one or more document relationship rules that pertain to document relationships between objects stored in a content management system;
identifying one or more workflows for a workflow management system;
identifying an event corresponding to a document managed by the content management system;
analyzing the event based upon the one or more document relationship rules;
determining whether a new action is triggered for either the content management system or the workflow management system;
implementing a new content management action for the document or another document that is in a document relationship with the document when a determination is made of the new action for the content management system, wherein the new content management action corresponds to execution of an applicable rule for the document relationship associated with the document; and
implementing a new workflow management system action for the document or the another document that is in the document relationship with the document when a determination is made of the new action for the workflow management system.

2. The method of claim 1, wherein a rules database is maintained, and the applicable rule from the rules database corresponds to the new content management action for the document.

3. The method of claim 1, wherein the event corresponding to the document managed by the content management system is analyzed to determine the relationships that the document has with other documents.

4. The method of claim 3, wherein a relationship definition table is maintained to define the document relationships, where defined relationships are tracked in a relationship table that identifies a set of documents that are related.

5. The method of claim 1, wherein the new workflow management system action is implemented corresponding to execution of another applicable rule for the document relationship associated with the document.

6. The method of claim 1, wherein the event corresponding to the document managed by the content management system corresponds to at least one of a content management system event or a workflow event.

7. The method of claim 1, wherein the document relationship corresponds to a parent-child relationship, and the applicable rule for the document relationship comprises one or more rules that govern the ability to act upon either a parent or a child document based upon the status of one or more parent or one or more child documents.

8. A non-transitory computer readable medium having stored thereon a sequence of instructions which, when stored in memory and executed by one or more processors causes the one or more processors to perform a set of acts, the set of acts comprising:
identifying one or more document relationship rules that pertain to document relationships between objects stored in a content management system;
identifying one or more workflows for a workflow management system;
identifying an event corresponding to a document managed by the content management system;
analyzing the event based upon the one or more document relationship rules;
implementing a new content management action for the document or another document that is in a document relationship with the document, wherein the new content management action corresponds to execution of an applicable rule for the document relationship associated with the document; and
implementing a new workflow management system action for the document or the another document that is in the document relationship with the document when a determination is made of the new action for the workflow management system.

9. The non-transitory computer readable medium of claim 8, wherein a rules database is maintained, and the applicable rule from the rules database corresponds to the new content management action for the document.

10. The non-transitory computer readable medium of claim 8, wherein the event corresponding to the document managed by the content management system is analyzed to determine the relationships that the document has with other documents.

11. The non-transitory computer readable medium of claim 10, wherein a relationship definition table is maintained to define the document relationships, where defined relationships are tracked in a relationship table that identifies a set of documents that are related.

12. The non-transitory computer readable medium of claim 8, wherein the new workflow management system action is implemented corresponding to execution of another applicable rule for the document relationship associated with the document.

13. The non-transitory computer readable medium of claim 8, wherein the event corresponding to the document managed by the content management system corresponds to at least one of a content management system event or a workflow event.

14. The non-transitory computer readable medium of claim 8, wherein the document relationship corresponds to a parent-child relationship, and the applicable rule for the document relationship comprises one or more rules that govern the ability to act upon either a parent or a child document based upon the status of one or more parent or one or more child documents.\

15. A system comprising:
a storage medium having stored thereon a sequence of instructions; and
one or more processors that execute the sequence of instructions to cause the one or more processors to perform a set of acts, the set of acts comprising: identifying one or more document relationship rules that pertain to document relationships between objects stored in a content management system; identifying one or more workflows for a workflow management system; identifying an event corresponding to a document managed by the content management system; analyzing the event based upon the one or more document relationship rules; determining whether a new action is triggered for either the content management system or the workflow management system; implementing a new content management action for the document or another document that is in a document relationship with the document, wherein the new content management action corresponds to execution of an applicable rule for the document relationship associated with the document; and implementing a new workflow management system action for the document or the another document that is in the document relationship with the document when a determination is made of the new action for the workflow management system.

16. The system of claim 15, wherein a rules database is maintained, and the applicable rule from the rules database corresponds to the new content management action for the document.

17. The system of claim 15, wherein the event corresponding to the document managed by the content management system is analyzed to determine the relationships that the document has with other documents.

18. The system of claim 17, wherein a relationship definition table is maintained to define the document relationships, where defined relationships are tracked in a relationship table that identifies a set of documents that are related.

19. The system of claim 15, wherein the new workflow management system action is implemented corresponding to execution of another applicable rule for the document relationship associated with the document.

20. The system of claim 15, wherein the event corresponding to the document managed by the content management system corresponds to at least one of a content management system event or a workflow event.

21. The system of claim 15, wherein the document relationship corresponds to a parent-child relationship, and the applicable rule for the document relationship comprises one or more rules that govern the ability to act upon either a parent or a child document based upon the status of one or more parent or one or more child documents.
